(19) United States
(12) Patent Application Publication
(10) Pub. No.: US 2026/0082452 A1
(43) Pub. Date: Mar. 19, 2026

(54) FLEXIBLE CUP WARMING PAD

(71) Applicant: Guangdong Willing Technology Corporation, Huizhou (CN)

(72) Inventors: Jingnong YE, Huizhou (CN); Shifa LUO, Huizhou (CN); Kunhuan FENG, Huizhou (CN)

(73) Assignee: Guangdong Willing Technology Corporation, Huizhou (CN)

(21) Appl. No.: 19/032,132

(22) Filed: Jan. 20, 2025

(30) Foreign Application Priority Data
Sep. 14, 2024 (CN) 202422270948.0

(51) Int. Cl. H05B 3/68; A47J 36/24; H05B 3/36

(52) U.S. Cl. CPC H05B 3/68; A47J 36/2433; A47J 36/2483; H05B 3/36; H05B 2203/013; H05B 2203/017

(57) ABSTRACT

A flexible cup warming pad includes a heater, a heat conductor and a base. The heater, the heat conductor and the base are all flexible structures. The heater is accommodated between the heat conductor and the base, the heat conductor and the base are embedded and fixed to each other. The flexible cup warming pad can be laid flat to heat the bottom of an item, or can be bent and fitted to the item.

### CROSS REFERENCE TO RELATED APPLICATIONS

This application claims priority benefits to Chinese Patent Application No. 2024222709480, filed on Sep. 14, 2024; the contents of which are incorporated herein by reference.

### TECHNICAL FIELD

The present disclosure relates to the technical field of heating devices, and in particular, to a flexible cup warming pad for heating and maintaining a constant temperature for containers such as cups and milk bottles.

### BACKGROUND

Existing cup warming pads are usually made of rigid materials, rendering them with fixed shapes and not adaptable to containers of different shapes and sizes.

### SUMMARY

A flexible cup warming pad includes a heater, a heat conductor and a base. The heater, the heat conductor and the base are all flexible structures. The heater is accommodated between the heat conductor and the base, the heat conductor and the base are embedded and fixed to each other. The flexible cup warming pad can be laid flat to heat the bottom of an item, or can be bent and fitted to the item.

### BRIEF DESCRIPTION OF THE DRAWINGS

The drawings constituting a part of the present disclosure are configured to provide a further understanding of the present disclosure. The embodiments of the present disclosure and their descriptions are used for explaining and do not constitute an improper limitation on the present disclosure.

FIG. 1 is a perspective view of a cup warming pad wrapped around an item.

FIG. 2 is a perspective view of a cup warming pad placed under a bottom of an item in a heating state.

FIG. 3 is a perspective view of a cup warming pad.

FIG. 4 is a top view of a cup warming pad and a power cord in an assembled state.

FIG. 5a is a sectional view of the cup warming pad taken along line A-A of FIG. 4.

FIG. 5b is an enlarged view of the cup warming pad at area M in FIG. 5a.

FIG. 6 is an exploded perspective view of a cup warming pad viewed at a first angle.

FIG. 7 is an exploded perspective view of a cup warming pad viewed at a second angle.

FIG. 8 is an exploded perspective view of a power supply assembly and a power cord of the cup warming pad.

FIG. 9 is a perspective view of the cup warming pad wrapped around the item in FIG. 1 viewed at another angle.

FIG. 10 is a perspective view of an insert and a wire clamping groove of a base.

FIG. 11 is a perspective view of a second surface of a heat conductor.

### DETAILED WAY

The present disclosure may be described in detail below with reference to the accompanying drawings and in conjunction with various embodiments. Each example is provided to explain but not limit the present disclosure. In fact, it may be clear to those of ordinary skill that modifications and variations may be made without departing from the scope or spirit of the present disclosure. For example, a feature shown or described as part of some embodiments may be used according to another embodiment to produce yet another embodiment. Therefore, it is intended that the present disclosure includes such modifications and variations within the scope of the appended claims and their equivalents.

In the description of the present disclosure, the terms “longitudinal”, “lateral”, “upper”, “lower”, “front”, “back”, “left”, “right”, “vertical”, “horizontal”, “top”, “bottom” and the like indicate the orientational or positional relationship based on the orientational or positional relationship illustrated in the drawings, which is only for the convenience of describing and eliminates the require the present disclosure to be constructed and operated in a specific orientation, and therefore cannot be understood as limiting the present disclosure. The terms “connected”, “connecting” and “arranged” used in the present disclosure should be understood in a broad sense. For example, it may be a fixed connection or a detachable connection; it may be directly connected or indirectly connected through an intermediate component; it may also be a wired electrical junction, a radio connection, or a wireless signal connection. For those of ordinary skill in the art, the specific meanings of the above terms may be understood according to the specific circumstances.

One or more examples of the present disclosure are illustrated in the attached drawings. Numbers and letter signs are used in the detailed description to refer to features in the drawings. Similar signs in the drawings and descriptions have been configured to refer to similar parts of the present disclosure. As used herein, the terms “first”, “second” and “third” are used interchangeably to distinguish one component from another and are not intended to indicate the position or importance of individual components.

According to some embodiments of the present disclosure, a pet pulling force test device is provided, which is configured to test the pulling force of a pet. A suitable traction rope 200 can be selected according to the magnitude of the pulling force. Moreover, it may record the pet's pulling force during its growth process, with changes in the pulling force serving as a health indicator. In addition, the current pulling force can be configured to match the pet with suitable individuals. For example, a pet having a greater pulling force is suitable for young and middle-aged people, but not for children and the elderly.

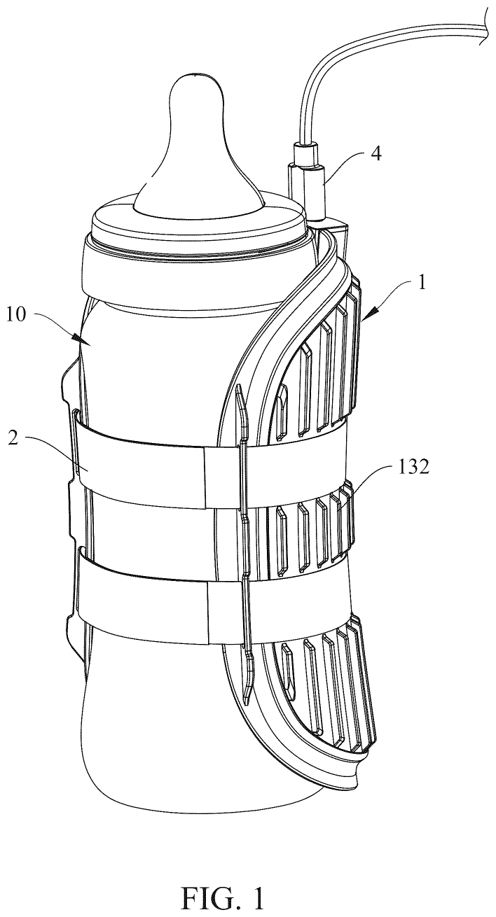

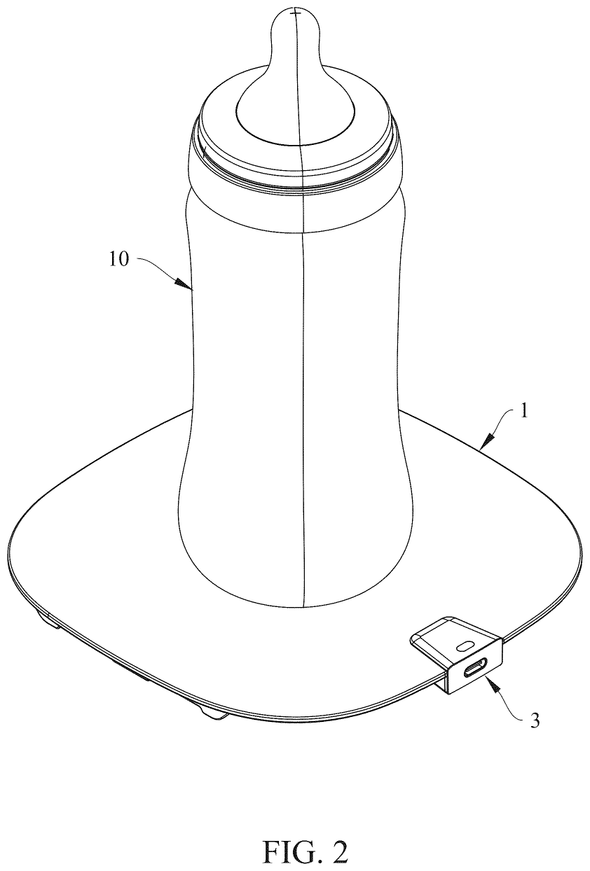

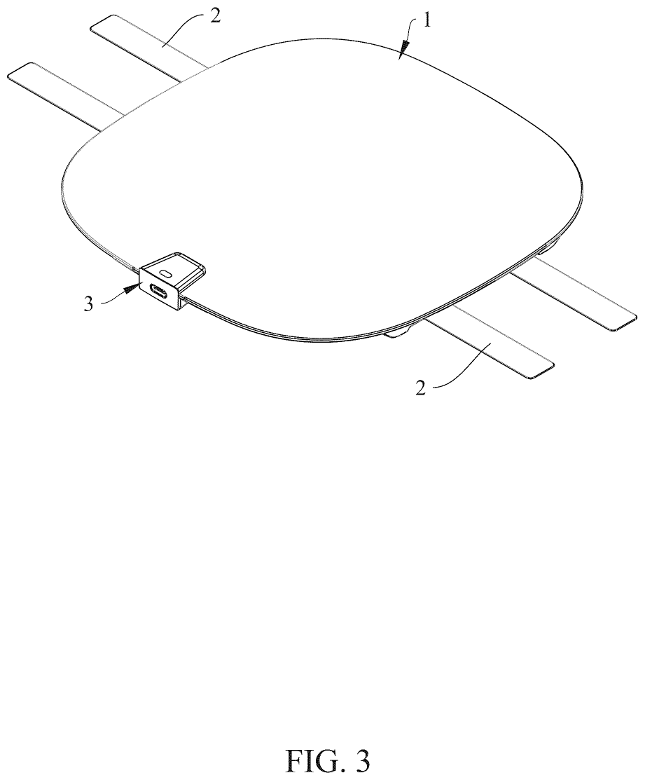

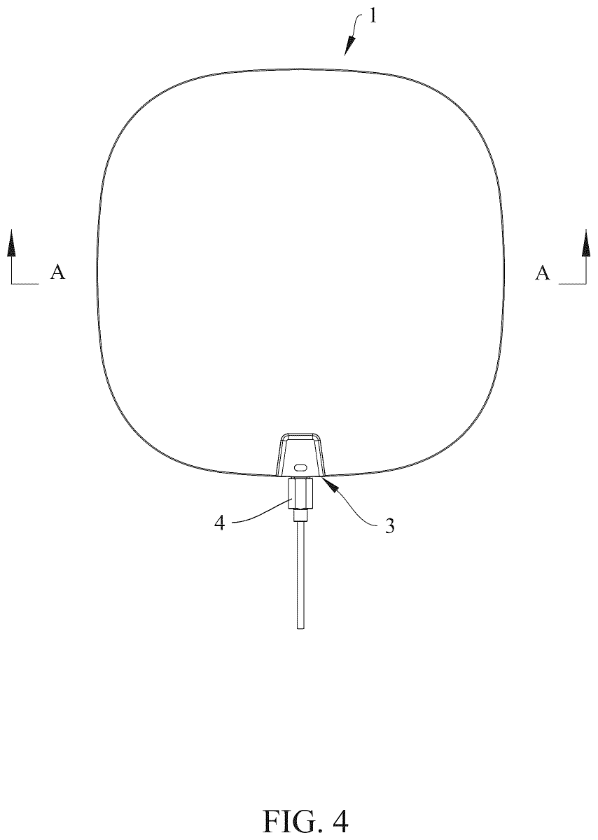

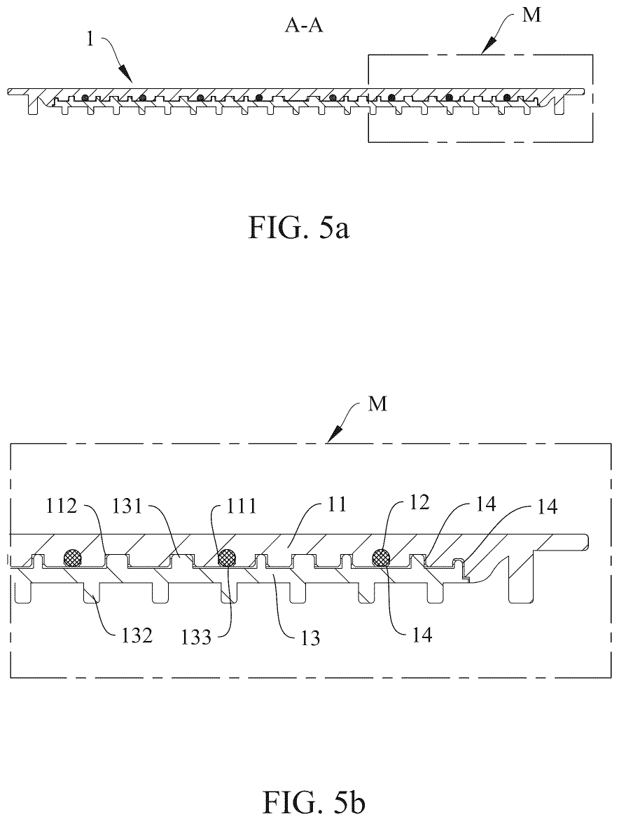

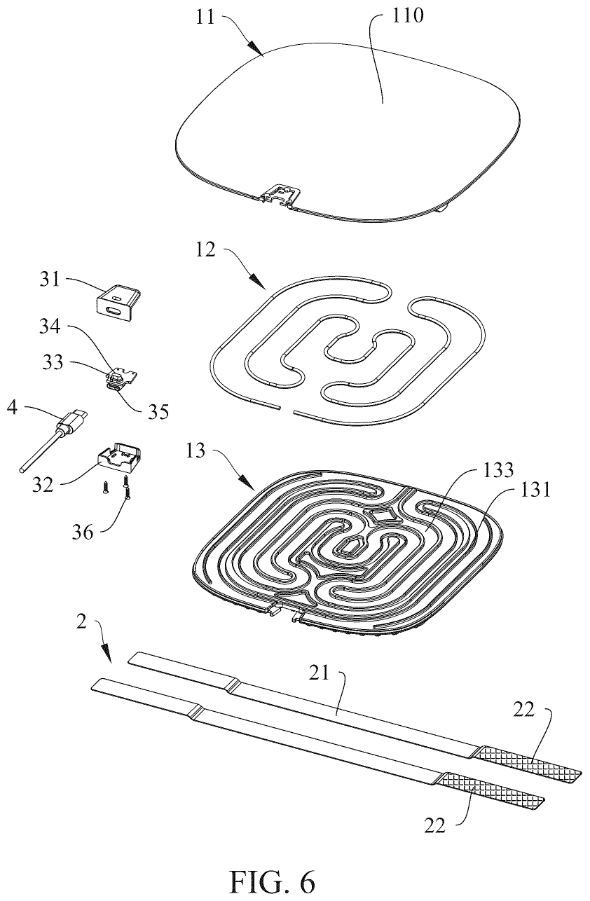

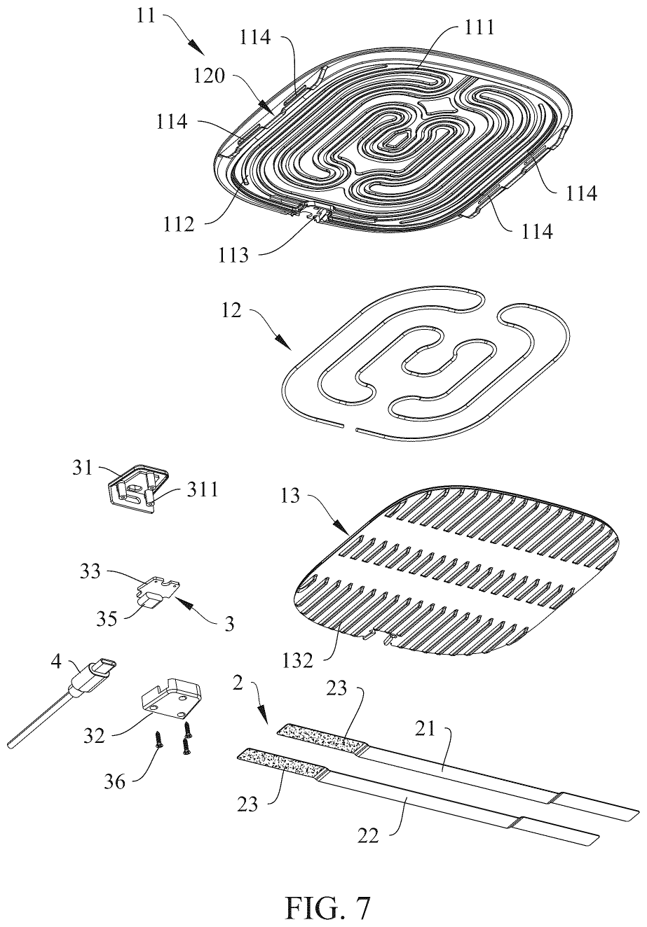

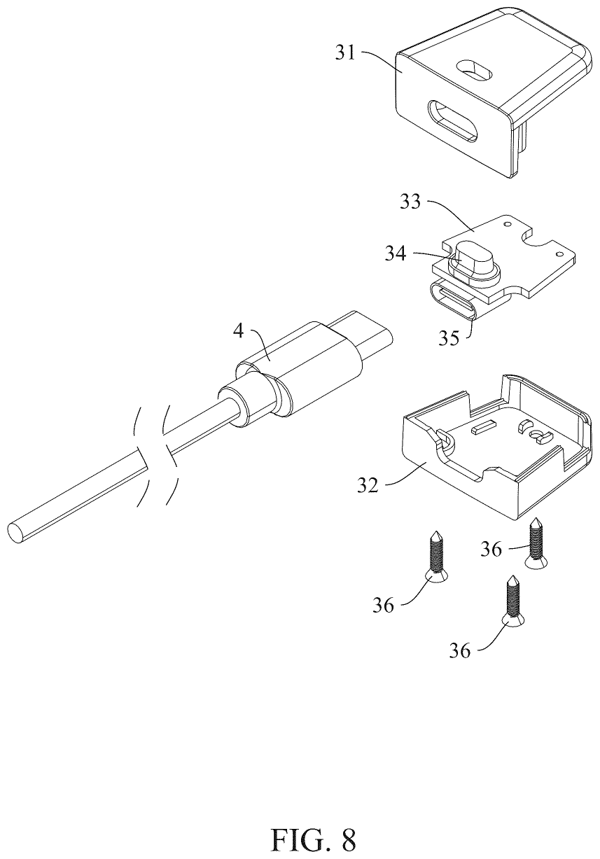

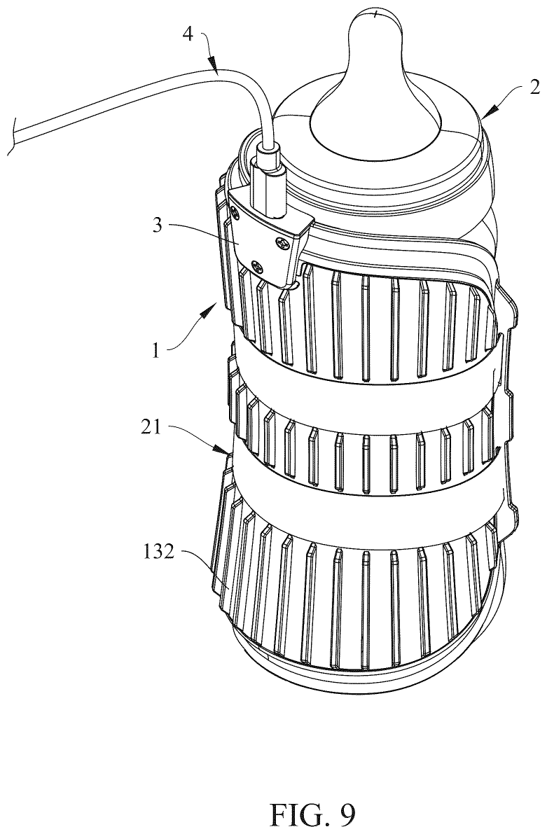

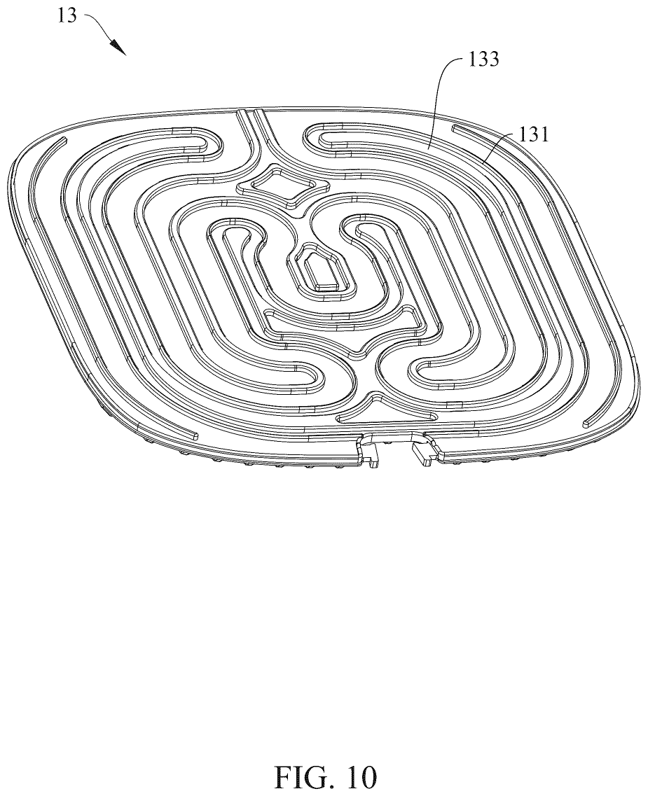

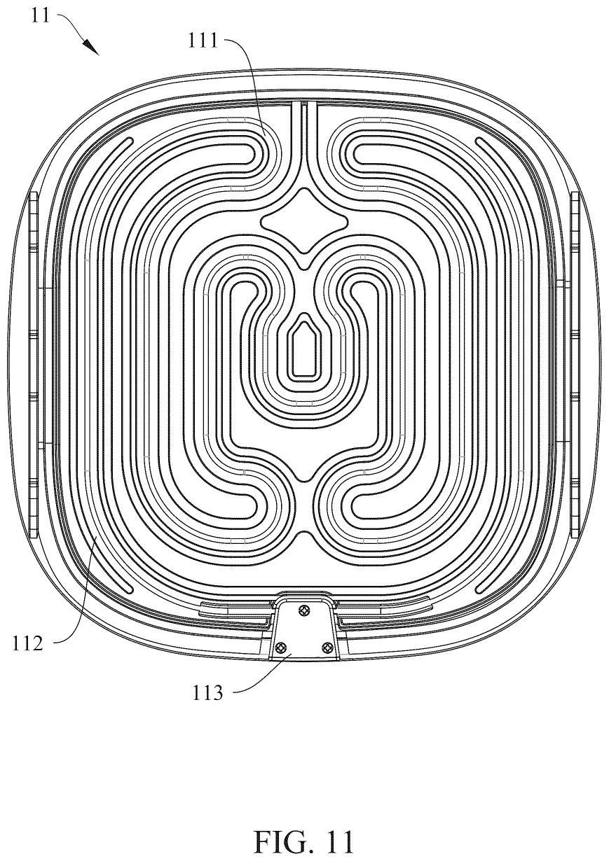

As shown in FIG. 1 to FIG. 11, according to some embodiments of the present disclosure, a flexible cup warming pad 1 is provided, including a base 13, a heat conductor 11 and a heater 12. The base 13, the heat conductor 11 and the heater 12 are all flexible structures. The heater 12 is sandwiched between the heat conductor 11 and the base 13. The heat conductor 11 and the base 13 are mutually embedded to be secured with each other.

In some embodiments, the base 13 and the heat conductor 11 are made of silicone material, which can be bent arbitrarily and is waterproof and electrically insulated. This also ensures safe operation even in a humid environment.

In some embodiments, the material of the heater 12 is selected from a single-layer insulating silicone heating wire or a double-layer insulating silicone heating wire, a graphene heating wire, a PI (Polyimide) heating film, a PET (Polyethylene terephthalate) heating film, a mica paper heating film, a metal heating film, or any combination of the above materials.

The flexible materials constructing the cup warming pad 1 can be adjusted in shape according to items 10 to be heated of different shapes and sizes, allowing the cup warming pad 1 to be placed flat in a horizontal state and or to be semi-enclosed in a vertical state, or used in other scenarios. The embedded fixation between the base 13 and the heat conductor 11 enables the heater 12 to be stably sandwiched between the heat conductor 11 and the base 13 to prevent displacement due to external pressure or movement.

In some embodiments, the heater 12 is arranged between the heat conductor 11 and the base 13. After the heat conductor 11 and the base 13 are embedded to each other, an adhesive layer 14 is arranged in the gaps among the three. The cup warming pad 1 thus arranged not only enhances the fixation among the heater 12, the heat conductor 11, and the base 13; but also provides a sealing and waterproof function, thereby improving overall stability and waterproof performance. The adhesive layer 14 includes solidified glue. Edges of the heat conductor 11 and the base 13 are both sealed with glue to form the adhesive layer 14, thereby further improving the integrity, stability and waterproofness of the cup warming pad 1.

In some embodiments, a first surface 110 of the heat conductor 11 is a smooth surface, and the smooth surface of the heat conductor 11 can be placed on or proximal to the item 10, allowing the cup warming pad 1 to heat the item 10.

In some embodiments, the cup warming pad 1 includes a fixing member 2, which is configured to secure the cup warming pad 1. It fits the cup warming pad 1 with an outer wall of the item 10 better, improving heating efficiency of the cup warming pad 1. Additionally, there is no need to secure the cup warming pad 1 manually, giving a more convenient and stable cup warming pad 1 during heating process.

In some embodiments, the fixing member 2 includes two straps 21, each with a Velcro including a loop surface 23 and a hook surface 22 respectively arranged at both ends of each strap 21. Two flat openings 114 for the straps to pass through are respectively arranged on left and right sides of the heat conductor 11 or the base 13. One end of each strap selectively passes through a flat opening 114 on the right side, and bypasses a bottom surface of the base 13 and then passes through the other corresponding flat opening 114 on the right side. The loop surface 23 and the hook surface 22 are selectively bonded to secure the cup warming pad 1. During use, a bonding area between the loop surface 23 and the hook surface 22 of the Velcro is adjusted according to an outer diameter of the item, thereby easily adjusting the dimension of the cup warming pad 1. This ensures that the cup warming pad 1 fits the item 10 tightly, thereby increasing use flexibility and adaptability.

In some embodiments, the heater 12 includes a heating wire, and an overall shape of the heating wire is a curved ring, or in the form a sinuous shape, or a grid shape, which is not limited to the above shapes. The heating wire is evenly distributed, and is interposed between the base 13 and the heat conductor 11. The uniform distribution of the heating wire allows heat to be evenly conducted to the item 10, avoiding localized overheating or uneven heating to the item 10.

In some embodiments, the heat conductor 11 is provided with a power supply fixing end 113, and a power supply component 3 is fixedly embedded in the power supply fixing end 113. The fixed embedded design reduces the risk of the power supply component 3 being detached due to accidental collision or movement, thereby preventing sudden power outages and improving safety of use. In addition, the embedded design of the power supply component 3 can be treated with sealing measures to improve waterproof and dustproof performance, which is particularly suitable for use in humid or dusty environments, such as kitchens or offices.

In some embodiments, the power supply component 3 is electrically connected to the heater 12. This ensures stable power transmission, reduces the risk of poor contact or circuit breakage, and ensures continuity and reliability of the heating function.

In some embodiments, the power supply component 3 includes a power interface 35, and the power interface 35 includes a USB interface or a Type-C interface. Receiving external power supply through the Type-C interface conforms to the general standards of modern electronic products and is convenient for use.

In some embodiments, the cup warming pad 1 is provided with a power cord 4. The power cord 4 is connected to the power interface 35, allowing the cup warming pad 1 to be electrically connected to an external power supply. The power supply component 3 provides power to the heater 2 and controls its working state.

In some embodiments, a second surface 120 of the heat conductor 11 is defined with a wire-receiving groove 111 protruding downward relative to the second surface 120 of the heat conductor 11. The quantity of the wire-receiving groove 111 can be designed as one or more. In some embodiments, the quantity of the wire-receiving groove 111 is one, the wire-receiving groove 111 is distributed on a continuous path, wounding up and down on the second surface 12 of the heat conductor 11, and is configured to accommodate and preliminarily secure the heating wire of the heater 12. In some embodiments, the quantity of the wire-receiving groove 111 is more than one, which are usually arranged symmetrically to ensure that the heating wires of the heater 12 are evenly distributed and stably fixed. Multiple wire-receiving grooves 111 are distributed along a specific path on the second surface 120 of the heat conductor 11, such as a spiral, straight line or grid shape, to accommodate heating wires of different shapes and lengths. This symmetrical arrangement not only contributes to the uniform conduction of heat, but also prevents the heating wires from being displaced or deformed due to external pressure. The wire-receiving groove 111 is configured to accommodate, wrap, and initially secure the heater 12. The material of the heater 12 is also flexible. Therefore, the heating wire of the heater 12 is prevented from popping out of the wire-receiving groove 111. The wire-receiving groove 111 ensures that the heating wire is fixed in a stable position inside the cup warming pad 1 to prevent displacement due to movement or deformation caused by an external pressure.

In some embodiments, a plurality of inserts 131 are provided above the base 13, and the gaps between adjacent inserts 131 form a wire-clamping groove 133. The quantity of the wire-clamping groove 133 on the base 13 can also be designed as one or more. In some embodiments, the quantity of the wire-clamping groove 133 is one, which is distributed on a continuous path in a wounding manner. In some embodiments, the quantity of the wire-clamping groove 133 is more than one, which are usually distributed in the gaps between adjacent inserts 131 to form a stable limiting structure. Multiple wire-clamping grooves 133 can be aligned or staggered with the wire-receiving groove 111 to enhance the fixation of the heating wire. For example, multiple symmetrically arranged wire-clamping grooves 133 cooperate together with the wire-receiving groove 111 to ensure the stability and position of the heating wire. The wire-receiving groove 111 is first configured to accommodate and preliminarily secure the heating wire of the heater 12 to ensure that it has a preliminary fixed position inside the cup warming pad. The wire-clamping groove 133 formed between adjacent inserts 131 on the base 13 cooperates with the wire-receiving groove 111 to further secure the heating wire. This double fixing mechanism ensures that the heating wire will not be displaced or loosened due to external pressure or vibration. When the heat conductor 11 is mounted on the base 13, the heating wire in the wire-receiving groove 111 may naturally fall into the wire clamping groove 133 defined by the base 13. The plurality of wire-clamping grooves 133 cooperates with the wire-receiving groove 111 to secure the heating wire of the heater 12, so as to maintain the distribution position of the heating wire and prevent it from shifting or loosening. The stable position of the heating wire ensures that the heat can be evenly distributed, further improving the heating efficiency.

In some embodiments, the wire-clamping groove 133 can also directly secure the heating wire, and an adhesive layer 14 is also provided at the gaps to ensure that the heating wire is stably fixed inside the cup warming pad 1, further improving heating efficiency and safety. This ensures that it is stably fixed inside the cup warming pad 1, reducing safety hazards caused by loose heating wires or poor contact, such as short circuits or local overheating.

In some embodiments, a recessed groove 112 is also defined by the heat conductor 11. The recessed groove 112 defined by the heat conductor 11 can be one or more, depending on actual needs. In some embodiments, the quantity of the recessed grooves 112 are multiple, which are arranged symmetrically to ensure the embedding and fixing between the heat conductor 11 and the base 13. The multiple recessed grooves 112 can be distributed along an edge or specific area of the heat conductor 11, and precisely aligned with the inserts 131 on the base 13 to allow the inserts 131 to be embedded into the recessed grooves 112 correspondingly, thereby forming a stable embedding structure. The embedded fixation between the heat conductor 11 and the base 13 enhances the connection strength between the two and ensures the stability of the overall structure, providing a stable heating efficiency.

In some embodiments, the heating wire of the heater 12 is placed in the wire-receiving groove 111 and cooperates with the wire-clamping groove 133 on the base 13 to ensure that the heating wire is stably fixed inside the cup warming pad 1. The heating wires can be arranged neatly, saving internal space and making the entire cup warming pad 1 more compact.

In some embodiments, a plurality of insulating ribs 132 of equal height spaced apart are provided below the base 13. The insulating ribs 132 prevent heat from being transferred to the bottom surface, reducing the risk of thermal damage to the desktop or other contact surfaces. The spaced insulating ribs 132 increases the space for air circulation, helps heat to be dissipated to the ambient environment faster, thereby improving heat dissipation efficiency of the cup warming pad and avoiding local overheating. The insulating ribs 132 also enhance structural strength and stability of the base 13, reducing deformation or tilting of the cup warming pad during use, and providing a more stable support. It also reduces the possibility of aging of the bottom surface due to direct contact with high temperature, extending the overall service life of the cup warming pad. The spaced-apart design between each group of heat-insulating ribs 132 reserves a channel for the straps 21, allowing a user to conveniently use the straps 21 to fix the cup warming pad on items to be heated of different shapes and sizes, such as cups or bottles. This also ensures that the cup warming pad fits the item tightly, thereby improving heating efficiency and convenience of use.

In some embodiments, the power supply component 3 includes an upper housing 31, a lower housing 32, and a chip control board 33 is accommodated between the upper housing 31 and the lower housing 32. The power interface 35 is electrically connected to the chip control board 33 and is connected to the power cord 4 through the power interface 35. The chip control board 33 controls a working state of the heater 12, maintains constant temperature, and provides a more comfortable use experience.

In some embodiments, the power supply component 3 also includes an indicator light 34, which is arranged on the chip control board 33 and electrically connected to the chip control board 33. The indicator light 34 is configured to display a working state of the cup warming pad 1, allowing a user to be aware of whether the device is working properly, thereby improving use convenience and safety.

In some embodiments, the power supply component 3 also includes a screw 36, the upper housing 31 is provided with a stud 311, and the lower housing 32 is defined with a screw hole, and the screw 36 passes through the screw hole, the power supply fixing end 113 is fixedly connected with the stud 311 in sequence.

The flexible cup warming pad 1 is proposed by the present disclosure. The heat conductor 11 of the cup warming pad 1 has a heat-conducting surface made of silicone, the heater 12 of the cup warming pad 1 has a heating body made of silicone, the heater 12 is connected to the power supply component 3, and the interior of the cup warming pad 1 is formed with a wire-receiving groove 111 for the heating wire to pass through, and the wire-receiving groove 111 is evenly distributed around the surface of the heat conductor 11. The cup warming pad 1 is provided with a power supply component 3, and the two ends of the heating wire of the heater 12 are connected to the power supply component 3. The chip control board 33 is provided inside the power supply component 3 to control the temperature. When using the cup warming pad 1, it can be placed flat for heating, or vertically half-surrounded items such as cups and milk bottles. As the wiring is arranged in a surrounding manner, the heating speed is fast. When working, the heat generated on the surface of the cup warming pad 1 is transferred to the cup or milk bottle body through the outer surface of the heat conductor 11, and the water inside the cup or milk bottle is heated. As the outer surface of the cup warming pad 1 is a flexible surface, cups or milk bottles with different shapes can be half-wrapped for heating, with the Velcro carried by the cup warming pad 1 secured. The outer surface of the base 13 of the cup warming pad 1 is formed with multiple heat-insulating ribs 132, and the heights of the multiple heat-insulating ribs 132 are equal. The heat conductor 11, the base and the heating wire of the cup warming pad 1 are made of flexible materials. The flexible cup warming pad 1 not only increases the contact area between the heat conductor 11 and the item 10, thereby achieving efficient heat conduction, but also increases safe and reliable electrical connections and enhances stability and service life of the overall structure.

The above description is only some embodiments of the present disclosure and is not intended to limit the scope of the present disclosure. Any equivalent changes or modifications made according to the structure, characteristics and principles described in the protection scope of the present disclosure should be included in the protection scope of the present disclosure.

What is claimed is:

1. A flexible cup warming pad comprising: a base, a heat conductor, and a heater; wherein the base, the heat conductor and the heater are all flexible; the heater is disposed between the heat conductor and the base; and the heat conductor and the base are embedded to each other.

2. The flexible cup warming pad according to claim 1, further comprising a power supply component, wherein the power supply component is electrically connected to the heater, and the power supply component comprises a power interface.

3. The flexible cup warming pad according to claim 1, wherein the heater comprises a heating wire, a shape of the heating wire is a curved ring, and the heater is evenly distributed between the base and the heat conductor.

4. The flexible cup warming pad according to claim 3, wherein a second surface of the heat conductor is defined with a wire-receiving groove, and the wire-receiving groove is configured to accommodate and wrap the heater.

5. The flexible cup warming pad according to claim 4, wherein a plurality of inserts are provided on the base, and gaps between adjacent inserts of the plurality of inserts form a wire-clamping groove, and the wire-clamping groove cooperates with the wire-receiving groove to secure the heating wire of the heater and maintain a distribution position the heating wire of the heater.

6. The flexible cup warming pad according to claim 5, wherein the heat conductor is defined with a recessed groove, and an inner wall of the recessed groove clamps at least of a portion of an outer wall of each insert of the plurality of inserts on the base.

7. The flexible cup warming pad according to claim 5, wherein the heater is placed in the wire-receiving groove, and an inner wall of the wire-clamping groove clamps at least a portion of an outer wall of the wire-receiving groove.

8. The flexible cup warming pad according to claim 1, wherein a plurality of heat-insulating ribs of equal height and spaced apart are provided below the base.

9. The flexible cup warming pad according to claim 2, wherein the power supply component comprises: an upper housing, a lower housing connected to the upper housing, and a chip control board disposed between the upper housing and the lower housing; the power interface is electrically connected to the chip control board; and the chip control board is configured to control a working state of the heater and is connected to a power cord through the power interface.

10. The flexible cup warming pad according to claim 9, wherein the power supply component further comprises an indicator light, the indicator light is electrically connected to the chip control board, and the indicator light is configured to display a working state of the flexible cup warming pad.

11. The flexible cup warming pad according to claim 7, wherein a gap between the base and the heater is provided with glue, a gap among the heater, the base and the heat conductor is provided with glue, and the glue solidifies to form an adhesive layer.

12. The flexible cup warming pad according to claim 1, wherein the cup warming pad further comprises a fixing member, and the fixing member is configured to secure the cup warming pad.

13. The flexible cup warming pad according to claim 12, wherein the fixing member comprises a strap, each of two ends of the strap is arranged with a loop surface or a hook surface; left and right sides of the heat conductor are respectively provided with a flat opening; one end of the strap is configured to pass through the flat opening on the left side, bypass a bottom surface of the base and pass through the flat opening on the right side; the loop surface and the hook surface are configured to be bondable for binding the cup warming pad.

14. The flexible cup warming pad according to claim 13, wherein at least two straps are provided, and at least two pairs of flat openings are provided, and each pair of the at least two pair of flat openings is symmetrically provided on the left and right sides of the heat conductor.

15. The flexible cup warming pad according to claim 1, wherein the heater is made of a single-layer or double-layer insulating silicone heating wire, a graphene heating wire, a PI heating film, a PET heating film, a mica paper heating film, a metal heating film, or any combination thereof.

16. The flexible cup warming pad according to claim 1, wherein a material of the base and the heat conductor is silicone.

17. The flexible cup warming pad according to claim 9, wherein the heat conductor is provided with a power supply fixing end, and the power supply component is fixedly embedded in the power supply fixing end.

18. The flexible cup warming pad according to claim 17, wherein the power supply component further comprises a screw, the upper housing is provided with a stud, and the lower housing is defined with a screw hole, the screw passes through the screw hole, the power supply fixing end and the stud are fixedly connected.

19. The flexible cup warming pad according to claim 4, wherein a first surface of the heat conductor is a smooth surface, and the smooth surface of the heat conductor is configured to place on or be proximal to an item for heating.

20. The flexible cup warming pad according to claim 2, wherein the power interface comprises a USB interface or a Type-C interface; an outside of the cup warming pad is provided with a power cord, and the cup warming pad is electrically connected to an external power source through the power interface and the power cord.
